(19) United States
(12) Patent Application Publication
(10) Pub. No.: US 2014/0371051 A1
(43) Pub. Date: Dec. 18, 2014

(54) Dry-sprayable unshaped refractory material

(71) Applicant: KROSAKIHARIMA CORPORATION, Fukuoka (JP)

(72) Inventors: Shunsuke Inadomi, Fukuoka (JP); Kazuhiro Honda, Fukuoka (JP); Aya Kusunoki, Fukuoka (JP); Kazuaki Haraguchi, Fukuoka (JP)

(21) Appl. No.: 14/361,953

(22) PCT Filed: Oct. 4, 2012
(86) PCT No.: PCT/JP2012/075798

§ 371 Date: May 30, 2014

(30) Foreign Application Priority Data
Dec. 1, 2011 (JP) 2011-263871

(51) Int. Cl. C04B 35/14

(52) U.S. Cl. CPC C04B 35/14
USPC 501/112; 501/121; 501/123; 501/118; 501/125

(57) ABSTRACT

The present invention addresses a technical problem of realizing a sprayable refractory material capable of, even when used in a dry-spraying installation process, ensuring mixability between a silica sol and a refractory composition to promote a hardening reaction, thereby achieving excellent durability. Provided is a dry-sprayable unshaped refractory material which comprises a refractory composition, and a silica sol containing a silica solid component in a concentration of 20 mass % to 50 mass %. The silica sol is added in such a manner that the silica solid component contained in an entirety of the silica sol reaches an amount of 3 mass % to 30 mass % with respect to and in addition to an entirety of the refractory composition assumed as 100 mass %, and the refractory composition contains a Mg- or Ca-containing compound having a particle size of 10 μm or less, wherein a ratio of a content of the Mg- or Ca-containing compound having a particle size of 10 μm or less in the refractory composition to a content of the silica solid component in the entirety of the silica sol is 0.02 or more.

### TECHNICAL FIELD

The present invention relates a sprayable unshaped refractory material for use in construction or repair of various furnaces (kilns) and metal containers/vessels, such as a blast furnace, a runner, a torpedo car, a converter furnace, a ladle, a secondary refining furnace, a tundish, a cement rotary kiln, a waste melting furnace, an incinerator, or a non-ferrous metal container/vessel.

### BACKGROUND ART

An installation process for an unshaped refractory material varies depending on the intended use. For example, in the case where an unshaped refractory material is used as a castable refractory material for linings of various furnaces and metal containers/vessels, etc., it is installed by subjecting a mixture of a refractory composition and water to a kneading step, a casting step, a curing step and a drying step. Among the steps, in the kneading step, the mixture is sufficiently kneaded by a mixer. Thus, even when an amount of addition of water is only about several % with respect to and in addition to an entirety of the refractory composition assumed as 100 mass %, it becomes possible to achieve sufficient kneading (see, for example, the following Patent Document 1).

An unshaped refractory material can also be used as a sprayable refractory material for construction or repair of furnaces. An installation process in this case is roughly classified into a wet-spraying installation process and a dry-spraying installation process. The wet-spraying installation process comprises: preliminarily sufficiently kneading a refractory composition and water by using a mechanical kneading mechanism such as a mixer; and pressure-feeding the resulting kneaded mixture by using a pump and spraying the fed mixture from a spray nozzle, while introducing thereinto air and a quick setting agent (hardener (curing agent)) at a distal end of the spray nozzle. The dry-spraying installation process comprises spraying a refractory composition in dry powder form from a spray nozzle, while adding thereto water and a quick setting agent (hardener) at a distal end of the spray nozzle, without involving any mechanical kneading mechanism.

As above, the dry-spraying installation process premises on addition of water at the distal end of the spray nozzle. Thus, the dry-spraying installation process is poor in mixability between a refractory composition and water, so that it is common practice to use the refractory composition with a considerably increased amount of addition of water. For example, in the dry-spraying installation process, the amount of addition of water is set to 10 mass % or more with respect to and in addition to an entirety of the refractory composition assumed as 100 mass % (see, for example, Comparative Example 2 in Table 1 in the following Patent Document 2). That is, the amount of addition of water in the dry-spraying installation process becomes greater than an amount of addition of water in the wet-spraying installation process and an amount of addition of water in the installation process for the castable refractory material.

In addition, the sprayable refractory material is required to have excellent durability (depositability, bondability, hot strength). For example, there has been known a sprayable refractory material intended to realize excellent durability, in which an ultra-fine magnesia powder and a silica sol are added to a base refractory composition primarily consisting of an alumina-spinel based composition (see, for example, the following Patent Document 3).

### LIST OF PRIOR ART DOCUMENTS

### Patent Documents

Patent Document 1: JP 2001-114571A

Patent Document 2: JP 2001-066068A

Patent Document 3: JP 05-148041A

### SUMMARY OF THE INVENTION

### Technical Problem

Generally, repair/construction using a sprayable refractory material is performed in both hot environments and cold environments, wherein the dry-spraying installation process is used in both of the two environments. On the other hand, generally, the wet-spraying installation process is not used for carrying out hot repairs (repairs in hot environments). This is because the wet-spraying installation process requires a preliminary kneading operation, so that there is a need for a cleanup work, such as a work of cleaning the kneading mechanism and a transfer hose for use in the pressure-feeding by a pump. Therefore, the wet-spraying installation process is not suitable for use in on-site installation with respect to refractory equipment being operating in hot environments.

As a matter of course, in the dry-spraying installation process, the sprayable refractory material is also required to have excellent durability. In this regard, as a technique of improving durability, the aforementioned Patent Document 3 describes adding a silica sol containing 15 to 25 mass % of SiO₂, in an amount of 6 to 8 mass %. When the amount of addition of water in the Patent Document 3 is calculated from an amount of addition of the silica sol, and an amount of water contained in the silica sol (the remainder, after excluding SiO₂), it is in the range of 4.5 to 6.8 mass % with respect to and in addition to 100 mass % of the refractory composition. However, as described in the aforementioned Patent Document 2, in the dry-spraying installation process, the amount of addition of water is required to be 10 mass % or more. That is, when the amount of addition of water is set to a value of about 4.5 to 6.8 mass %, as in the Patent Document 3, the amount of addition of water becomes insufficient. If the amount of addition of water is insufficient, it becomes impossible to disperse water over the entire refractory composition, thereby causing deterioration in mixability between the silica sol and the refractory composition, which leads to a problem that, along with deterioration in the mixability, depositability and bondability of an installed body are deteriorated, resulting in deterioration in durability.

The Patent Document 3 further describes inducing a sol-gel reaction based on the silica sol and the ultra-fine magnesia powder, and hardening (curing) the refractory composition by means of this reaction. In this regard, a particle size of the ultra-fine magnesia powder is important in order to promote a refractory composition hardening (curing) reaction. For example, if the particle size of the ultra-fine magnesia powder is excessively large, an amount of elution of magnesia into the silica sol is reduced, so that it becomes impossible to efficiently perform the hardening reaction.

Although the Patent Document 3 describes the use of an ultra-fine magnesia powder, it does not specifically describe the particle size of the ultra-fine magnesia powder. Thus, there is a possibility that the refractory composition hardening reaction is not promoted.

For promoting the refractory composition hardening reaction, a content of silica (SiO₂) and a content of ultra-fine magnesia powder are also important. For example, if the content of ultra-fine magnesia powder with respect to silica is excessively small, the amount of elution of magnesia into the silica sol is reduced, so that it becomes impossible to promote the hardening reaction.

If the refractory composition hardening reaction is not promoted as mentioned above, shape retainability of the refractory composition is deteriorated, thereby leading to deterioration in deposit rate, i.e., deterioration in durability.

The present invention addresses a technical problem of realizing a sprayable refractory material capable of, even when used in a dry-spraying installation process, ensuring mixability between a silica sol and a refractory composition to promote a hardening reaction, thereby achieving excellent durability.

### Solution to the Technical Problem

The present invention provides a dry-sprayable unshaped refractory material which comprises a refractory composition, and a silica sol containing a silica solid component in a concentration of 20 mass % to 50 mass %, wherein the silica sol is added in such a manner that the silica solid component contained in an entirety of the silica sol reaches an amount of 3 mass % to 30 mass % with respect to and in addition to an entirety of the refractory composition assumed as 100 mass %, and the refractory composition contains a Mg- or Ca-containing compound having a particle size of 10 μm or less, and wherein a ratio of a content of the Mg- or Ca-containing compound having a particle size of 10 μm or less in the refractory composition to a content of the silica solid component in the entirety of the silica sol is 0.02 or more.

### Effect of the Invention

In the present invention, the Mg- or Ca-containing compound (hereinafter referred to as “Mg/Ca compound”) has a fine particle size of 10 μm or less, and the ratio of the content of the Mg/Ca compound to the content of the silica solid component coming from the silica sol is 0.02 or more, so that a refractory composition hardening reaction based on a reaction between the silica sol and the Mg/Ca compound is moderately promoted. This makes it possible to realize a sprayable unshaped refractory material capable of, even when used in a dry-spraying installation process, achieving excellent durability.

### DESCRIPTION OF EMBODIMENTS

A dry-sprayable unshaped refractory material comprises a refractory composition and a silica sol.

As used in the present invention, the term “refractory component” is a generic term for a composition comprising, in addition to a refractory aggregate, a binder, and a hardener (curing agent) (in the present invention, an Mg/Ca compound is used). As the refractory aggregate, it is possible to use alumina, magnesia or the like which are used in conventional sprayable unshaped refractory materials. As the binder, it is possible to use a dispersant such as silicate binder or phosphate binder, a thickener, fibers, or the like

The silica sol is used under the condition that it contains a silica solid component in a concentration of 20 mass % to 50 mass %. If the concentration of the silica solid component is less than 20 mass %, a sol-gel reaction between the silica sol and the hardener is not sufficiently induced, so that, due to insufficient hardening, the refractory composition flows down from an installation surface, causing deterioration in depositability and bondability. The deterioration in depositability and bondability leads to deterioration in hot strength, resulting in deterioration in durability. On the other hand, if the concentration of the silica solid component exceeds 50 mass %, a viscosity of the silica sol is excessively increased, thereby causing deterioration in mixability between the silica sol and the refractory composition. For compensating for deterioration in mixability between the silica sol and the refractory composition, it is necessary to increase an amount of addition of water. That is, it is necessary to increase an amount of addition of the silica sol. However, as the amount of addition of the silica sol is increased, a silica concentration in an installed body is increased, so that a melting point of the installed body itself is lowered. As a result, the hot strength is significantly deteriorated. Moreover, a large amount of addition of the silica sol is also undesirable in terms of cost. As the silica sol, it is possible to use a commercially available product.

In the present invention, the silica sol is added in such a manner that the silica solid component contained in an entirety of the silica sol reaches an amount of 3 mass % to 30 mass % with respect to and in addition to an entirety of the refractory composition assumed as 100 mass %. If an amount of the silica solid component in the entirety of the added silica sol (amount of the silica solid component coming from the added silica sol) is less than 3 mass % with respect to and in addition to the entirety of the refractory composition assumed as 100 mass %, the sol-gel reaction between the silica sol and the hardener is not sufficiently induced, so that, due to insufficient hardening, the refractory composition flows down from an installation surface, causing deterioration in depositability and bondability. The deterioration in depositability and bondability leads to deterioration in hot strength, resulting in deterioration in durability. On the other hand, if the amount of the silica solid component in the entirety of the added silica sol exceeds 30 mass % with respect to and in addition to the entirety of the refractory composition assumed as 100 mass %, a silica concentration in an installed body is increased, so that a melting point of the installed body itself is lowered. As a result, the hot strength is significantly deteriorated.

Preferably, water is added in an amount of 10 mass % to 30 mass % with respect to and in addition to the entirety of the refractory composition assumed as 100 mass %. This makes it possible to disperse water over the entire refractory composition to thereby sufficiently ensure mixability between the silica sol and the refractory composition. In this case, the amount of water (water amount) means an amount of water in the entirety of the added silica sol (amount of water coming from the added silica sol), or a sum of the amount of water in the entirety of the silica sol and an amount of water separately added to the silica sol.

If the added water amount is less than 10 mass % with respect to and in addition to the entirety of the refractory composition assumed as 100 mass %, mixability between the refractory composition and the silica sol is deteriorated, and consequently deterioration in depositability and bondability is likely to occur. The deterioration in depositability and bondability leads to deterioration in hot strength, resulting in deterioration in durability. On the other hand, if the added water amount exceeds 30 mass % with respect to and in addition to the entirety of the refractory composition assumed as 100 mass %, shape retainability of an installed body is deteriorated due to an increase in water amount, thereby deterioration in depositability and bondability is likely to occur. The deterioration in depositability and bondability leads to deterioration in hot strength, resulting in deterioration in durability.

In the present invention, in order to induce a refractory composition hardening reaction based on a reaction with the silica sol, the Mg/Ca compound having a particle size of 10 μm or less is contained in the refractory composition to serve as a hardener. If the particle size of the Mg/Ca compound exceeds 10 μm, it becomes impossible to efficiently induce the hardening reaction. In view of promoting the hardening reaction, it is preferable that the Mg/Ca compound has a specific surface area of 10 m²/g or more. As the Mg/Ca compound, it is possible to use magnesia, slaked lime, or the like.

A ratio of a content of the Mg/Ca compound in the refractory composition to a content of the silica solid component in the entirety of the added silica sol is set to 0.02 or more. If the content of the Mg/Ca compound in the refractory composition is reduced, and thereby the ratio of the content of the Mg/Ca compound to the content of the silica solid component in the entirety of the silica sol becomes less than 0.02, an amount of elution of Mg ions or Ca ions into the silica sol is reduced, so that it becomes impossible to perform the hardening reaction. On the other hand, if the amount of the silica solid component in the entirety of the silica sol is increased due to a large amount of addition of silica, and thereby the ratio of the content of the Mg/Ca compound in the refractory composition to the content of the silica solid component in the entirety of the silica sol becomes less than 0.02, the silica solid component in an installed body is excessively increased, so that a melting point of the installed body itself is lowered. As a result, the hot strength is significantly deteriorated.

Further, the ratio of the content of the Mg/Ca compound in the refractory composition to the content of the silica solid component in the entirety of the added silica sol is preferably set to 3 or less. This is because, if the ratio of the content of the Mg/Ca compound in the refractory composition to the content of the silica solid component in the entirety of the added silica sol exceeds 3, a content of an ultra-fine magnesia or calcia powder is extremely increased with respect to silica, so that the hardening reaction is excessively promoted, which is likely to cause installation problems, such as dripping from a spray nozzle and clogging of a spray nozzle.

Preferably, the refractory composition for use in the present invention contains, in addition to the Mg/Ca compound having a particle size of 10 μm or less, a fine particle component having a particle size of 0.075 mm or less, in an amount of 15 mass % to 50 mass %. This makes it possible to improve installability in a dry-spraying installation process. Specifically, if the content of the fine particle component having a particle size of 0.075 mm or less is less than 15 mass %, and a rate of a coarse particle component is relatively increased, a rebound phenomenon of the refractory composition on an installation surface is more likely to occur, thereby causing lowering in deposit rate. The lowering in deposit rate inevitably leads to lowering in deposit rate of the hardener (Mg/Ca compound) for hardening the silica sol, thereby causing deterioration in hardenability (curability) and deterioration in installability. On the other hand, if the content of the fine particle component having a particle size of 0.075 mm or less exceeds 50 mass %, it becomes difficult to disperse the silica sol over the entire refractory composition, thereby causing deterioration in mixability between the refractory composition and the silica sol. For compensating for the deterioration in mixability, it is necessary to increase an amount of addition of the silica sol. However, if the amount of addition of the silica sol becomes excessive, a silica concentration in an installed body becomes excessively high, so that the hot strength is significantly deteriorated, which is likely to impair durability. Moreover, a large amount of addition of the silica sol is also undesirable in terms of cost, because it leads to a significant increase in cost.

Preferably, in the present invention, the dry-sprayable unshaped refractory material comprises one or more selected from the group consisting of metal Al, Si and Fe and added in a total amount of 0.5 mass % to 10 mass % with respect to and in addition to the entirety of the refractory composition assumed as 100 mass %. This makes it possible to improve hot strength of an installed body to thereby obtain an installed body having excellent durability. Specifically, metal Al, Si and Fe can be formed as micro oxides during installation, and the micro oxides fill voids in an installed body to densify the installed body itself, thereby improving the hot strength. Among the metals, metal Al is particularly preferable. Metal Al also reacts with silica in the silica sol to form micro oxides, so that the densification is further progressed, thereby significantly improving the hot strength. If the total amount of addition of one or more of metal Al, Si and Fe is less than 5 mass %, the hot-strength improving effect of the addition is not observed. On the other hand, if the total amount exceeds 10 mass %, an amount of the one or more metals left in an installed body without undergoing an oxidation reaction is increased, so that any further improvement in the hot strength is not observed. Moreover, such an excessive addition leads to an increase in cost.

The dry-sprayable unshaped refractory material of the present invention described as above is obtained by adding a silica sol to the refractory composition in a dried powder state, or a mixture of the refractory composition and the one or more metals added thereto, at a distal end of a spray nozzle for use in the dry-spraying installation process, and then sprayed from a tip of the spray nozzle to form an installed body on an installation surface.

### EXAMPLES

Table 1 presents a raw material composition and an evaluation result for each Inventive Example of the dry-sprayable unshaped refractory material of the present invention. Further, Table 2 presents a raw material composition and an evaluation result for each Comparative Example.

TABLE 1

| | | | | | Inventive Example | | | | | | | |
|---|---|---|---|---|---|---|---|---|---|---|---|---|
| | | | | | 1 | 2 | 3 | 4 | 5 | 6 | 7 | 8 |
| Refractory | Aggregate | Alumina | 5~3 | mm | — | — | — | — | — | — | — | — |
| composition | | Alumina | 3~1 | mm | 30 | 30 | 30 | 30 | 30 | 30 | 30 | 30 |
| (mass %) | | Alumina | ≦1 | mm | 30 | 30 | 30 | 30 | 30 | 30 | 30 | 30 |
| | | Alumina | ≦0.075 | mm | 10 | 10 | 10 | 10 | 10 | 10 | 10 | 10 |
| | | Spied | ≦1 | mm | — | — | — | — | — | — | — | — |
| | | Spied | ≦0.035 | mm | — | — | — | — | — | — | — | — |
| | | Alumina-silica | 3~1 | mm | 10 | 10 | 10 | 10 | 10 | 10 | 10 | 10 |
| | | | ≦1 | mm | 5 | 5 | 5 | 5 | 5 | 5 | 5 | 5 |
| | | Silicon carbide | ≦1 | mm | 10 | 10 | 10 | 10 | 10 | 10 | 10 | 10 |
| | | | ≦0.075 | mm | 10 | 10 | 10 | 10 | 1 | 10 | 10 | 10 |
| | | Binder (except hardener) | ≦0.075 | mm | 5 | 5 | 5 | 5 | 5 | 5 | 5 | 5 |
| | Hardener | Spied line | ≦0.080 | mm | — | 0.3 | — | — | — | — | — | — |
| | | Magnesia | >0.010 | mm | — | — | — | — | — | — | — | — |
| | | Magnesia | ≦0.010 | mm | 1 | — | 1 | 1 | 1 | 1 | 1 | 1 |

| | | | | | | | | |
|---|---|---|---|---|---|---|---|---|
| Specific surface area | 100 | 20 | 100 | 100 | 100 | 100 | 100 | 100 |
| [BET] (cm2/g) of hardener | | | | | | | | |

| | | | | | | | | | | |
|---|---|---|---|---|---|---|---|---|---|---|
| Meal Aluminum *1 | ≦0.075 | mm | 5 | 5 | 5 | 5 | 5 | 5 | — | — |
| Meal silicon *1 | ≦0.075 | mm | — | — | — | — | — | — | 5 | — |

| Amount (mass %) of fine powder having particle size of | | 30 | 30 | 39 | 30 | 10 | 60 | 30 | 30 |
|---|---|---|---|---|---|---|---|---|---|
| 0.075 mm or less, in refractory composition | | | | | | | | | |
| Concentration (mass %) of silica sol | | 30 | 30 | 29 | 50 | 30 | 30 | 30 | 30 |
| Amount of addition (mass %) of silicon sol | | 30 | 29 | 18 | 60 | 15 | 25 | 20 | 20 |
| Amount (mass %) of solid composition silica sol | | 6 | 6 | 3.6 | 30 | 4.5 | 3.6 | 6 | 6 |
| with respect to 100 mass % of refractory composition | | | | | | | | | |
| Amount (mass %) of addition of water with respect to 100 | | 14 | 14 | 14 | 30 | 10.5 | 17.5 | 14 | 14 |
| mass % of refractory composition | | | | | | | | | |
| Content of of MgCa compound/content of SiO2 | | 0.17 | 0.05 | 0.08 | 0.08 | 0.21 | 0.13 | 0.17 | 0.17 |
| Physical property value | Hot strength (1450° C.) | ⊚ | ⊚ | ◯ | ◯ | ◯ | ◯ | ◯ | Δ |
| Spray test | Deposit ability | ⊚ | ⊚ | ◯ | ◯ | Δ | Δ | ⊚ | ⊚ |
| | Bondability | ⊚ | ⊚ | ◯ | ◯ | Δ | Δ | ⊚ | ⊚ |
| | Dried state of installed after | ⊚ | ⊚ | ⊚ | ⊚ | ⊚ | ⊚ | ⊚ | ⊚ |
| | spraying | | | | | | | | |

| | | | | | | | | |
|---|---|---|---|---|---|---|---|---|
| Compressive evaluation | ⊚ | ⊚ | ◯ | ◯ | ◯ | ◯ | ◯ | ◯ |

*1: Mass % with respect to and in addition to an entirety of a refractory composition assumed as 100 mass %.

TABLE 2

| | | | | | Comparative Example | | | | | |
|---|---|---|---|---|---|---|---|---|---|---|
| | | | | | 1 | 2 | 3 | 4 | 5 | 6 |
| Refractory | Aggregate | Alumina | 5~3 | mm | — | — | — | 32 | — | — |
| composition | | Alumina | 3~1 | mm | 30 | 30 | 30 | 33 | 30 | 30 |
| (mass %) | | Alumina | ≦1 | mm | 30 | 30 | 30 | 33 | 30 | 30 |
| | | Alumina | ≦0.075 | mm | 5 | 10 | 10 | 33 | 10 | 10 |
| | | Spied | ≦1 | mm | — | — | — | 10 | — | — |
| | | Spied | ≦0.035 | mm | — | — | — | 10 | — | — |
| | | Alumina-silica | 3~1 | mm | 10 | 10 | 10 | — | 10 | 10 |
| | | | ≦1 | mm | 5 | 5 | 5 | — | 5 | 5 |
| | | Silicon carbide | ≦1 | mm | 10 | 10 | 10 | — | 10 | 10 |
| | | | ≦0.075 | mm | 10 | 10 | 10 | — | 10 | 10 |
| | | Binder (except | ≦0.075 | mm | 5 | 5 | 5 | — | 5 | 5 |
| | | hardener) | | | | | | | | |
| | Hardener | Spied line | ≦0.080 | mm | 0.3 | — | — | — | — | — |
| | | Magnesia | >0.010 | mm | — | — | — | — | — | 3 |
| | | Magnesia | ≦0.010 | mm | — | 1 | 0.5 | 1 | 0.05 | — |

| | | | | | | |
|---|---|---|---|---|---|---|
| Specific surface area [BET] | 80 | 100 | 100 | 100 | 100 | 19 |
| (cm2/g) of hardener | | | | | | |

| | | | | | | | | |
|---|---|---|---|---|---|---|---|---|
| Meal Aluminum *1 | ≦0.075 | mm | — | 5 | 5 | — | 5 | 5 |
| Meal silicon *1 | ≦0.075 | mm | — | — | — | — | — | — |

| Amount (mass %) of fine powder having particle size | | 30 | 30 | 39 | 30 | 10 | 60 |
|---|---|---|---|---|---|---|---|
| of 0.075mm or less, in refractory composition | | | | | | | |
| Concentration (mass %) of silica sol | | — | 12 | 60 | 23 | 50 | 30 |
| Amount of addition (mass %) of silicon sol | | — | 33 | 60 | 8 | 20 | 20 |
| Amount (mass %) of silica added composition silica sol with | | — | 1.7 | 36 | 2.9 | 6 | 6 |
| respect to 100 mass % of refractory composition | | | | | | | |
| Amount (mass %) of addition of water with respect to | | 10 | 13 | 24 | 68 | 34 | 34 |
| 100 mass % of refractory composition | | | | | | | |
| Content of MgCa compound/content of SiO2 | | — | 0.50 | 0.01 | 0.5 | 0.01 | 9 |
| Physical property | Hot strength (1450° C.) | X | Δ | Δ | Δ | Δ | ◯ |
| value | | | | | | | |
| Spray test | Depositability | ◯ | X | X | X | X | X |
| | | | Flow- | Flow- | Reduction in | Flow- | Flow- |
| | | | down | down | deposit | down | down |
| | | | due to | due to | due to | due to | due to |
| | | | insuf- | insuf- | insuf- | insuf- | insuf- |
| | | | ficient | ficient | ficient | ficient | ficient |
| | | | hardening | hardening | mixing | hardening | hardening |
| | Bondability | Δ | X | X | X | X | X |
| | | | Unevalu- | Unevalu- | Extremely | Unevalu- | Unevalu- |
| | | | able | able | weak | able | able |
| | | | | | bonding | | |
| | | | | | force | | |
| | Dried state of installed | X | X | X | X | X | X |
| | body after spraying | Insuf- | Unmeas- | Unmeas- | Unmeas- | Unmeas- | Unmeas- |
| | | ficient | urable | urable | urable | urable | urable |
| | | dried | | | | | |
| | | state of | | | | | |
| | | installed | | | | | |
| | | body | | | | | |

| | | | | | | |
|---|---|---|---|---|---|---|
| Compressive evaluation | X | X | X | X | X | X |

*1: Mass % with respect to and in addition to an entireity of a refractory composition assumed as 100 mass %.

Spraying of a dry-sprayable unshaped refractory material comprising each of the refractory compositions presented in Tables 1 and 2 was performed. Specifically, as for Inventive Example, spraying was performed after adding, at a distal end of a spray nozzle, a silica sol to each of the refractory compositions presented in Table 1, or a mixture of the refractory composition and metal Al or metal Si added thereto. Further, as for Comparative Examples 2 to 7 in Table 2, spraying was performed after adding, at a distal end of a spray nozzle, a silica sol to each of the refractory compositions presented in Table 2, in the same manner as described above. As for Comparative Example 1 in Table 2, spraying was performed after adding water at a distal end of a spray nozzle, without adding any silica sol. As the “binder (except hardener)” presented in Tables 1 and 2, a binder consisting primarily of silicate soda was used.

Each of installed bodies obtained in Inventive Examples and Comparative Examples was subjected to evaluation on: hot strength; depositability during the spray test; bondability; and a dried state of an installed body after spraying, and further subjected to comprehensive evaluation based on the respective evaluation results.

The hot strength of each installed body was determined as: excellent (double circle mark) when a measurement value thereof is equal to or greater than 1.0 MPa; good (circle mark) when the measurement value is in the range of 0.5 MPa to less than 1.0 MPa; mediocre (triangle mark) when the measurement value is in the range of 0.1 MPa to less than 0.5 MPa; and bad (cross mark) when the measurement value is less than 0.1 MPa.

The depositability was evaluated by a rate of deposit of each refractory composition onto an installation surface, and determined as: excellent (double circle mark) when a ratio of an amount of deposit of the refractory composition onto the installation surface to an amount of consumption of the refractory composition is equal to or greater than 90 mass %; good (circle mark) when the ratio is in the range of 85 mass % to less than 90 mass %; mediocre (triangle mark) when the ratio is in the range of 80 mass % to less than 85 mass %; and bad (cross mark) when the ratio is less than 80 mass %.

The bondability was evaluated by a level of peeling and dropping of each refractory composition bonded to the installation surface, and determined as: excellent (double circle mark) when the deposited refractory composition was hardened without peeling and dropping; good (circle mark) when the deposited refractory composition was mostly hardened although a part thereof peeled and dropped; mediocre (triangle mark) when there were several peeled and dropped portions; and unevaluatable (cross mark) when the refractory composition was not deposited to preclude the evaluation.

The dried state of each installed body after spraying was evaluated by: holding each installed body just after spraying, in a furnace heated to 1000° C. or more, for 3 minutes; and, after extracting the installed body from the furnace, cutting the installed body to check a dried state of an inside thereof. The dried state was determined as: excellent (double circle mark) when the installed body was fully dried in a cut cross-section thereof; good (circle mark) when the installed body was mostly dried although insufficient drying was slightly observed; mediocre (triangle mark) when a plurality of insufficiently-dried portions were observed; and bad (cross mark) when one-half or more of the cross-section of the installed body was in an insufficiently-dried state.

The comprehensive evaluation was determined as: excellent (double circle mark) when a sample has two or more double circle marks without any triangle mark and cross mark; good (circle mark) when a sample has one double circle mark and at most two triangle marks without any cross mark; mediocre (triangle mark) when a sample has at most one cross mark and two or more triangle marks without any double circle mark; and bad (cross mark) when a sample has two or more cross marks, irrespective of other evaluation results.

As presented in Table 1, in all of Inventive Examples, the comprehensive evaluation was determined as excellent (double circle mark) or good (circle mark), i.e., a good result can be obtained.

However, Inventive Examples 5 and 6 are inferior to the remaining Inventive Examples, in that the evaluation on depositability and bondability is mediocre (triangle mark). This is probably because, in Inventive Example 5, the fine particle component having a particle size of 0.075 mm or less is contained in the refractory composition, in a relatively small amount of 10 mass %, and, in Inventive Example 6, the fine particle component having a particle size of 0.075 mm or less is contained in the refractory composition, in a relatively large amount of 60 mass %. An effective way for improving depositability and bondability is that the fine particle component having a particle size of 0.075 mm or less is contained in an amount of 15 mass % to 50 mass %, as mentioned above. This is verified by the Inventive Examples.

Further, Inventive Example 8 is inferior to the remaining Inventive Examples, in that the evaluation on heat strength is mediocre (triangle mark). This is probably because, in Inventive Example 8, the metal (Al, Si or Fe) is not added. An effective way for improving heat strength of an installed body is to add one or more selected from the group consisting of metal Al, Si and Fe, in a total amount of 0.5 mass % to 10 mass % with respect to and in addition to the entirety of the refractory composition assumed as 100 mass %, as mentioned above. This is verified by the Inventive Examples. In addition, from comparison between Inventive Example 1 and Inventive Example 7, it is proven that metal Al is particularly effective in improving heat strength of an installed body.

On the other hand, in Comparative Example 1 presented in Table 2 which is a conventional typical dry-sprayable unshaped refractory material without addition of a silica sol, the hot strength was relatively low, and the dried state of each installed body after spraying was poor.

In Comparative Example 2, the concentration of the silica solid component of the silica sol (In Tables, it is described as “concentration of silica sol”) is less than a lower limit of the range defined in the present invention, and the amount of the silica solid component in the silica sol with respect to the entirety of the refractory composition assumed as 100 mass % is also less than a lower limit of the range defined in the present invention. Therefore, flow-down of the refractory composition due to insufficient hardening was observed on the installation surface, and depositability was poor.

In Comparative Example 3, the concentration of the silica solid component of the silica sol, and the amount of the silica solid component in the silica sol with respect to the entirety of the refractory composition assumed as 100 mass % are greater than upper limits of the ranges defined in the present invention. Therefore, the amount of the silica solid component in the entirety of the silica sol becomes excessive, thereby causing deterioration in the hot strength. In Comparative Example 3, the ratio of the content of Mg/Ca compound/the content of SiO₂ is less than a lower limit of the range defined in the present invention. Therefore, an amount of magnesia as a hardener becomes insufficient with respect to the amount of the silica solid component, so that flow-down of the refractory composition due to insufficient hardening was observed on the installation surface, and depositability was poor.

Comparative Example 4 is a dry-sprayable unshaped refractory material equivalent to that described in the aforementioned Patent Document 3. An amount of addition of the silica sol is insufficient, so that the amount of the silica solid component in the silica sol with respect to the entirety of the refractory composition assumed as 100 mass %, and the water amount, are less than upper limits of the ranges defined in the present invention. Thus, due to insufficient mixing, depositability was poor, and bondability was also poor.

In Comparative Example 5, an amount of magnesia as the Mg/Ca compound is insufficient, and thereby the ratio of the content of Mg/Ca compound/the content of SiO₂ is 0.01 which is less than the lower limit of the range defined in the present invention. Therefore, flow-down of the refractory composition due to insufficient hardening was observed on the installation surface, and depositability was poor.

In Comparative Example 6, the particle size of magnesia as the hardener (Mg/Ca compound) is greater than 10 μm (0.010 mm), so that flow-down of the refractory composition due to insufficient hardening was observed on the installation surface, and depositability was poor.

1. A dry-sprayable unshaped refractory material comprising a refractory composition, and a silica sol containing a silica solid component in a concentration of 20 mass % to 50 mass %,
wherein
the silica sol is added in such a manner that the silica solid component contained in an entirety of the silica sol reaches an amount of 3 mass % to 30 mass % with respect to and in addition to an entirety of the refractory composition assumed as 100 mass %, and
the refractory composition contains a Mg- or Ca-containing compound having a particle size of 10 μm or less,
and wherein
a ratio of a content of the Mg- or Ca-containing compound having a particle size of 10 μm or less in the refractory composition to a content of the silica solid component in the entirety of the silica sol is 0.02 or more.

2. The dry-sprayable unshaped refractory material as defined in claim 1, which comprises water added in an amount of 3 mass % to 30 mass % with respect to and in addition to the entirety of the refractory composition assumed as 100 mass %.

3. The dry-sprayable unshaped refractory material as defined in claim 1, wherein the refractory composition contains a fine particle component having a particle size of 0.075 mm or less, in an amount of 15 mass % to 50 mass %.

4. The dry-sprayable unshaped refractory material as defined in claim 1, wherein the Mg- or Ca-containing compound has a specific surface area of 10 m²/g or more.

5. The dry-sprayable unshaped refractory material as defined in claim 1, which comprises one or more selected from the group consisting of metal Al, Si and Fe and added in a total amount of 0.5 mass % to 10 mass % with respect to and in addition to the entirety of the refractory composition assumed as 100 mass %.
